(19) United States
(12) Patent Application Publication
(10) Pub. No.: US 2004/0111359 A1
(43) Pub. Date: Jun. 10, 2004

(54) Business method for credit verification and correction

(76) Inventor: John J. Hudock, Wilkes-Barre, PA (US)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/454,435

(22) Filed: Jun. 4, 2003

Related U.S. Application Data
(60) Provisional application No. 60/385,538, filed on Jun. 4, 2002.

(51) Int. Cl. G06F 17/60

(52) U.S. Cl. 705/38

(57) ABSTRACT

A method for correcting and verifying consumer credit. Credit scores receive from credit scoring services determine loan awards and interest rates. Information at credit repositories is often incorrect. Credit reporting agencies report credit scores to requesting users. A consumer verifying credit information inputs requested data and requests a credit score. The application and credit scores are transmitted via a communications network. The applicant verifies information through inputs, interacting with a system hosting the credit correcting software. Repositories are contacted to correct and verify incorrect information. The program also identifies and generates a list of incorrect information. Repositories are given this information and requested to verify and correct the incorrect information, resulting in a new score with corrected credit information, typically resulting in a better credit score. Better credit scores and correct information permits users to better evaluate the credit risks associated with decisions based upon credit scores.

### CROSS REFERENCE TO RELATED APPLICATION(S)

This application claims priority from U.S. provisional application No. 60/385,538 filed Jun. 4, 2003, which is incorporated by reference as if fully set forth.

### FIELD OF INVENTION

This invention pertains to computerized information management involving the processing and use of credit data and information which is used for creating credit scores, and involves the correction and verification of credit data, and more particularly an automatic method for verifying, requesting correction and correcting credit data for consumers with the potential result of creating better credit scores.

### BACKGROUND OF THE INVENTION

Credit reporting is a long established practice of determining a consumer's credit worthiness. There are presently three major national credit reporting repositories, Thompson, Ramo & Wooldridge which was purchased by Experian in 1996, TransUnion Credit Information Company, Inc. (TU), and Equifax. Credit bureaus operated or affiliated with each of the credit repositories will request a report from its repository. The repositories obtain information from regional or local credit agencies (CRA), of which there are currently over 2000, and many other sources including credit and financial granters, inputted information from credit agencies and otherwise. Currently, some parties can request what is called a tri-merge report, which assimilates all of the data from the three repositories into one report. However, many businesses only access a single credit agency for regional or local reports. The same is true when businesses report to the repositories and credit agencies consumer credit information, and only report such information to local or regional credit agencies. Thus, each repository may have different information regarding the consumer's credit, and each repository updates its information differently. Furthermore, each repository may have different information regarding a single consumer, as each repository obtains its information from different sources usually being local or regional sources.

### SUMMARY

The present invention generally comprises a method for consumer and business credit verification and repair. The method is implemented through a consumer, who may begin the process individually or at the request of a business, using a computer program, website, intranet, server or other central processing unit which receives inputs from the applicant either directly or over a communications system. The consumer's inputs are then used to request credit data and information from the credit agencies and repositories regarding the consumer in order to create an information profile of the consumer. The information profiles are used to create a credit report or score for the applicant. The inputs are transmitted over a communications system to the a credit agency, who will request the information from the repositories, or the inputs are transmitted directly to the credit repositories. The repositories transmit the credit report and/or score to the applicant or other requesting party over a communications system. The software program, central processing unit, or website is able to communicate with both the applicant or requesting party and the credit repositories. The score and report is evaluated for incorrect information and inconsistencies, both by the applicant and via the software program used by the applicant or requesting party and based on a computer readable format, including, but not limited to a hard drive, disk, CD, website, server or otherwise that searches for incorrect data. The consumer and software program will identify any incorrect information, and the credit repositories are contacted via a communications system, mail or fax, and are requested to correct the incorrect data. The credit information is reaccessed as a follow up to determine whether the information has been corrected, and the consumer and software program once again verify the whether the information is correct. The program, website or central processing unit will track the requested changes to the credit report and may have access to the repositories to correct information directly.

Minor errors occur in a majority of credit reports and a majority of these errors negatively affects the credit score of the applicant. The current method of using and verifying credit scores is provided using a labor intensive process. The repositories are now also permitting requests for credit information to be corrected using e-mail. The typical credit report is pulled by a requesting party who uses the report and a score provided with the credit report to determine an applicant's ability to obtain financing. Usually the tradelines and information is not repaired or reviewed by the consumer. If a consumer requests a credit report and finds incorrect information, typically the consumer is not aware of the deadlines and time issues that may make additional information incorrect. The consumer then must send a letter, fax or e-mail to the central repositories requesting that specific tradelines be corrected. The current process does not promote a complete repair or verification of tradeline data. Thus, many consumers' credit scores are not accurate. The current process may also involve the use of a credit company who will access a credit report for a consumer and aid the consumer in the repair. However, the process requires manual repairs, and does not allow the consumer to immediately access the credit tradelines as well as having a software program that immediately identifies correctable information for the consumer. Furthermore, the current process is slow, and the credit repositories only make changes at specific times during each month. An objective of the present invention is to quickly correct data that requires no verification and to promote quick and efficient resolutions to verified incorrect data by having a quick and efficient verification process between the applicant and the credit repositories.

The current methods also have a problem in that many of the credit reports are viewed as a single credit report. The three major credit reporting agencies do not always have the same information on the credit report that they provide to the consumers. The present invention pulls a tri-merge report that obtains all the credit report information from the three (3) reporting agencies and identifies duplicate information or missing information in order to provide each repository with correct credit information.

An object of the invention is to provide a computer or online based credit verification and correcting system that permits the consumer and credit correcting software to interact in order to provide complete credit correcting coverage. The invention will also exclude the repositories and CRA's from selling or exchanging the consumer's credit information until the information has been corrected, unless otherwise authorized by the consumer.

Another object of the invention is to determine credit scores for loans and to evaluate an applicant's credit and debt ratio, request correction and verify that applicant's credit is correct and permit the applicant to receive a better credit score and therefore obtain lower loan rates and beneficial rates based on credit scoring.

Another object of the invention is to provide a more accurate and precise scoring for credit evaluation by correcting incorrect and errored data used or collected at all the major credit repositories, CRA's and tradelines.

Another object of the invention is to make the credit scoring and correction system more efficient, by making the credit report information directly available and interactive with consumers and businesses, so that they may verify the accuracy and completeness of the information and have it corrected without the manual work that is currently required to correct credit report data.

Another object of the invention is to have the website and computer program access the central repositories directly and request the correction or to fix the tradeline information directly or indirectly.

Another object of the invention is to permit the consumer to have the credit repositories stop selling the consumer's credit information to third parties until the credit information has been corrected and verified by the consumer.

Another object of the invention is to provide a method to reverse bankruptcy records and remove them from the credit reports and to provide an automatic method to obtain a credit card. See methods that are unique.

### BRIEF DESCRIPTION OF THE DRAWING(S)

The invention will be more fully understood by reference to the following drawings which are for illustrative purposes only:

FIG. 1 is an illustration of a flow diagram of the apparatus of the present invention.

FIG. 1a is a diagram showing some of the hardware employed to perform the functions shown in FIG. 1.

FIG. 2 is the functional flow diagram showing the overall method of operation of the apparatus shown is FIG. 1.

FIGS. 2a and 2b are flow diagrams showing the steps of the FIG. 2a flow diagram in greater detail.

FIG. 3 is a functional flow diagram showing the security program module of FIG. 2 in greater detail.

FIG. 4 is a functional flow diagram showing the credit information module of FIG. 2 in greater detail.

FIG. 5 is a functional flow diagram showing the credit and tradeline collection module of FIG. 2 in greater detail.

FIG. 6 is a functional flow diagram showing the credit and tradeline analysis module of FIG. 2 in greater detail.

FIG. 7 is a functional flow diagram showing the credit and tradeline verification and correction request module of FIG. 2 in greater detail.

FIG. 8 is a functional flow diagram showing the consumer form creation module of FIG. 2 in greater detail.

FIG. 9 is a functional flow diagram showing the specialty services module of FIG. 2 in greater detail..

FIG. 9a is a functional flow diagram showing the opt-out sequence module of FIG. 2 in greater detail.

FIG. 9b is a functional flow diagram showing the bankruptcy reversal module of FIG. 2 in greater detail.

FIG. 10 is a functional flow diagram showing the business programs module of FIG. 2 in greater detail.

Further detailed description of the drawings and of the invention set forth below and is also contained in the Appendix containing pages A-1 through A-52 and accompanying this specification hereto after the claims.

### DETAILED DESCRIPTION OF THE PREFERRED EMBODIMENT(S)

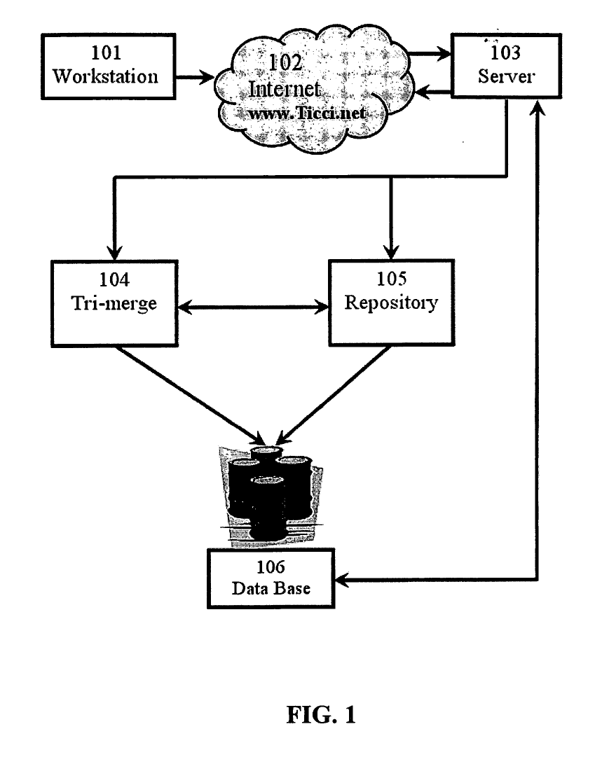

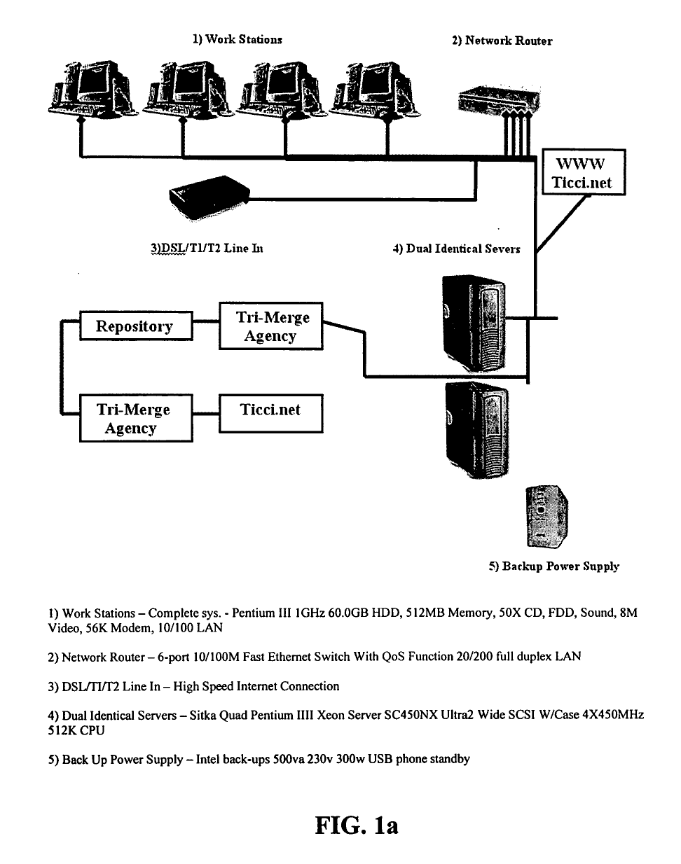

Referring more specifically to the drawings, for illustrative purposes, the present invention is embodied in the system configuration and flow diagrams generally shown in FIG. 1 through FIG. 10. The system and method of operation based on the illustrative configurations may vary as to the details of its configuration and operation, and the illustrations should not be construed as limiting the basic concepts to a specific physical configuration.

Referring to FIGS. 1 and 1a, the invention generally comprises an online semi automated credit verification and correction apparatus as shown. The invention includes a plurality of program modules that permit online credit verification and subsequent correction of credit data, with the programs to be executed using data processors or workstations of individuals or businesses

A workstation 101 is interconnected and provides a consumer access via online or other communication system 102 to a central processing unit or server 103 (TICCI central processing unit) for security and consumer verification. The TICCI central processing unit contains a database of consumer identification and information as well as program modules and data modules The TICCI central processing unit contains a security module which protects the database information and information about the consumer. The security module contains a looped connection that provides additional security. The TICCI central processing unit is connected via online or other communication system to a Tri Merge Agency 104 and/or Credit Repositories 105 for obtaining consumer credit information. The Tri Merge Agency contacts the credit repositories 105 for obtaining consumer credit information. The consumer information is transmitted to the TICCI central processing unit and is stored in a database 106. The TICCI central processing unit 103 compiles the consumer information in the database into a credit report in order to evaluate the credit information and to perform credit correction and scoring. The TICCI central processing unit processes and analyzes the tradeline information indicated in the report and transmits the tradelines to the consumer for verification. The consumer verifies the information and incorrect information is transmitted to the TICCI central processing unit, which sends correction requests to the Repositories and Tri Merge Agencies. The Tri Merge Agencies and Repositories perform tradeline corrections or verify incorrect information. The TICCI Central Processing unit contacts the Tri Merge agencies and the repositories in order to re-verify the consumer's information through a new verification and correction process, until the consumer information is correct. Pages A2-A3 of the Appendix respectively provide detailed text for the steps and hardware of FIGS. 1 and 1a.

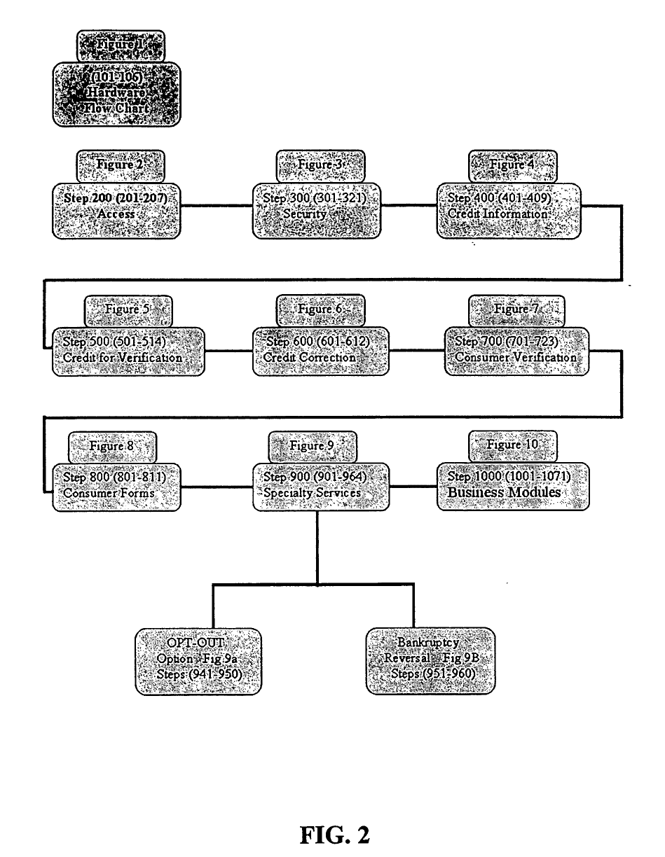

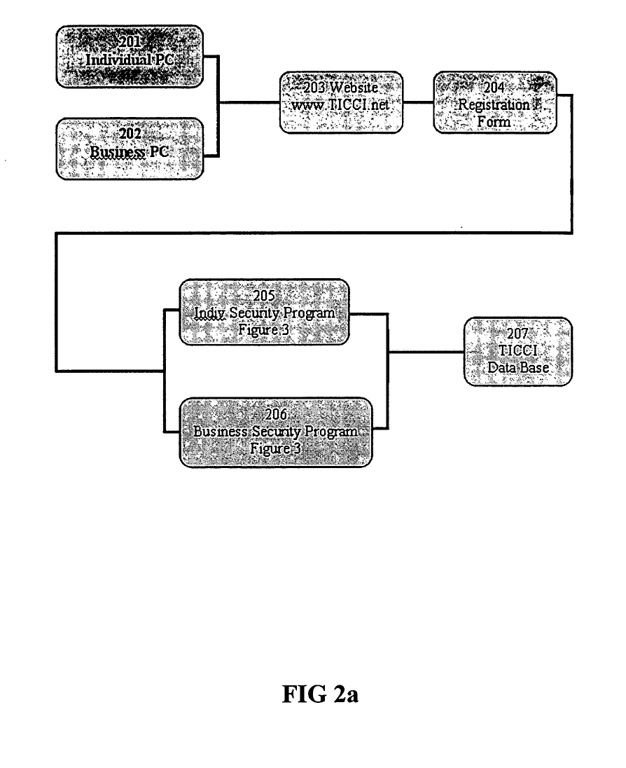

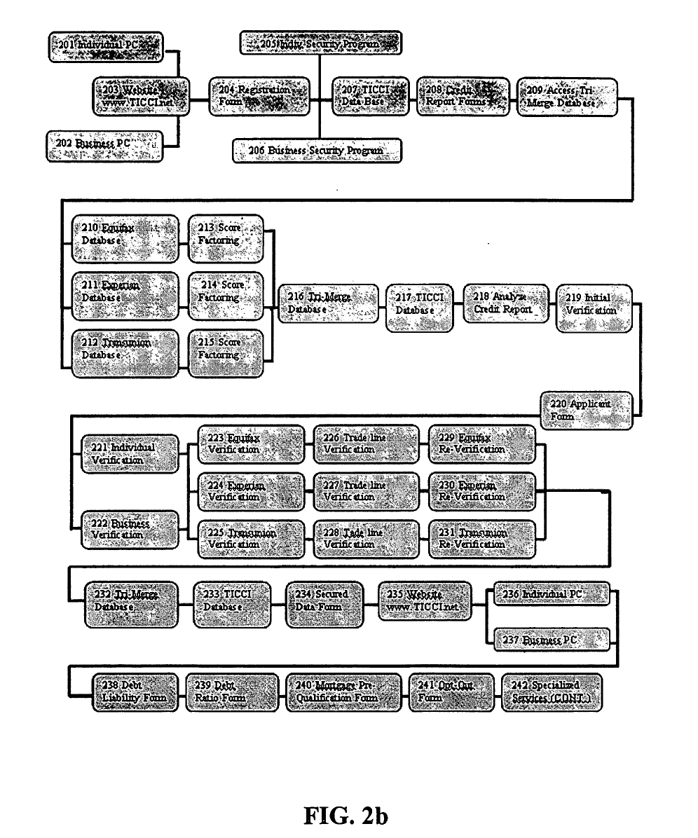

Referring to FIGS. 2-2b, the overall system configuration and operation is shown. The initial access by a consumer to the TICCI database starts at the Access Log-In 200, where the consumer inputs personal information in order to gain access and provide information to the central processing unit. The Access step is a login step that provides the TICCI central processing unit with information relating to the consumer and provides a connection between the consumer and the TICCI central processing unit. The consumer information is processed through the Security Module 300, that provides protection of the consumer information and creates a secure connection between the consumer either as an individual or to the consumer through a third party business. The Credit Information Module 400 prompts the consumer to input personal information that is transferred to the TICCI central processing unit for creating a personal profile for the consumer. The Credit Verification Module 500 has the TICCI central processing unit contact the tri-merge agencies and the repositories and uses the consumer's personal information, to request and receive the consumer's credit information and credit report. The consumer's credit is verified by both the consumer and the TICCI central processing unit via a computer program. The Credit Correction Module 600 requests the correction of incorrect credit and tradeline information contained in the consumer's credit information and credit report. The Consumer Verification Module 700 permits the consumer to verify the tradeline and credit information in order to determine if any incorrect information is listed in the consumer's credit. The repositories are contacted and requested to correct the incorrect consumer credit information. The Generated Consumer Form Module 800 creates forms and verifies the consumer's credit information to create forms that are used for credit handling and assessment. The Specialty Services Module 900 has different options that a consumer may choose regarding credit services based upon a consumer's credit information. The Business Module 1000 provides the consumer with specific consumer related services involving the use of a consumer's credit information for obtaining consumer loans and credit based consumer products with third party businesses. Pages A4-A8 of the Appendix respectively provide detailed text for each of the steps shown in FIGS. 2-2b.

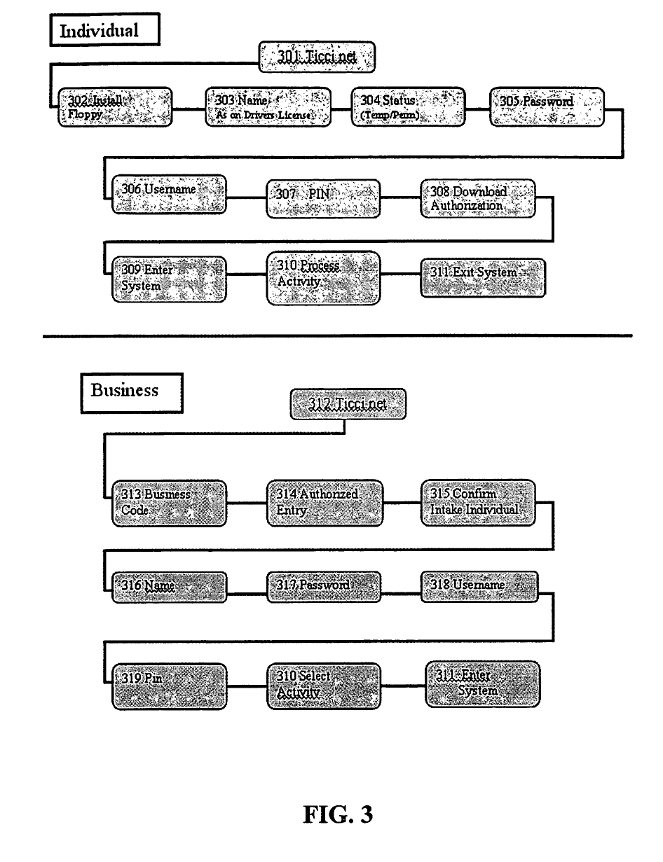

FIG. 3 is a functional flow diagram of the Security Module for both an individual consumer accessing the TICCI central processing unit via a personal workstation or for an individual accessing the TICCI central processing unit via a third party business with business access.

For an individual accessing the TICCI central processing unit via a personal workstation, the consumer accesses the TICCI central processing unit via an online or other communication system 301. The consumer is prompted to install a floppy disk or other storage media 302. The consumer enters personal identification information 305 which may include a name, status, password, username, pin number and is provided a download authorization 306 once the consumer is registered or if the proper personal information is given by a consumer, a recurring consumer is granted access to the TICCI central processing unit. The consumer is continuously looped with the TICCI central processing unit, and is required to have the storage media in constant connection with the TICCI central processing unit and is required to use the same storage media in order to be granted access to the TICCI processing unit without contacting a service representative to gain access to the consumer's account. The consumer is granted system access 307 if the personal identification information and storage media correspond to the information contained in the database. So long as the storage media is looped with the TICCI central processing unit, the consumer is able to perform process activity 308 which are the functions available for correcting credit and the other modules 400 to 1000. As the consumer exits the system 309, a security code will be identified to the storage media, and will enable a quicker verification and log in the next time the consumer enters the system.

For a consumer accessing the TICCI central processing unit from a business workstation, the consumer will access the TICCI central processing unit via an online or other communication system 303, and the business code 304 will be verified by the TICCI central processing unit. The business workstation will have already been granted a security authorization prior to the consumer's use. The consumer enters personal identification information 305 which may include a name, status, password, username, pin number and is provided a system access 307 once the consumer is registered or if the proper personal information is given by a consumer, a recurring consumer is granted access to the TICCI central processing unit. The consumer may perform process activity 308 which are the functions available for correcting credit and the other modules 400 to 1000. As the consumer exits the system 309, the consumer personal identification information is stored in the database for future retrieval. Pages A9-A10 of the Appendix provide detailed text for the steps shown in FIG. 3.

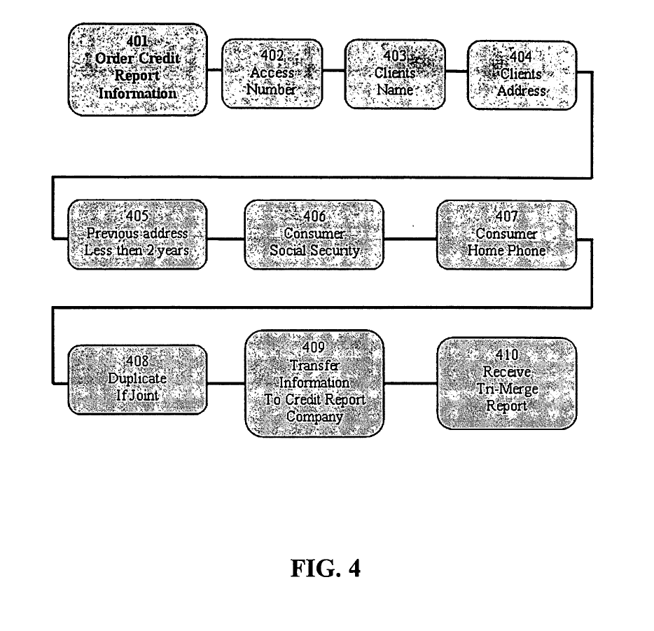

FIG. 4 is a functional flow diagram showing the credit information module 400. The TICCI central processing unit contacts the repositories or the Tri Merge agencies and orders a credit report 401 of the consumer. The TICCI central processing unit sends personal information of the consumer to the Tri-Merge agencies and repositories via online or other communication system in order to gain access 402 to the consumer's credit report. The Tri Merge agency or repository contacted sends a credit report to the TICCI central processing unit via online or other communication system 403. The credit report information is placed into the database 404. Page A11 of the Appendix provides detailed text for the steps of FIG. 4.

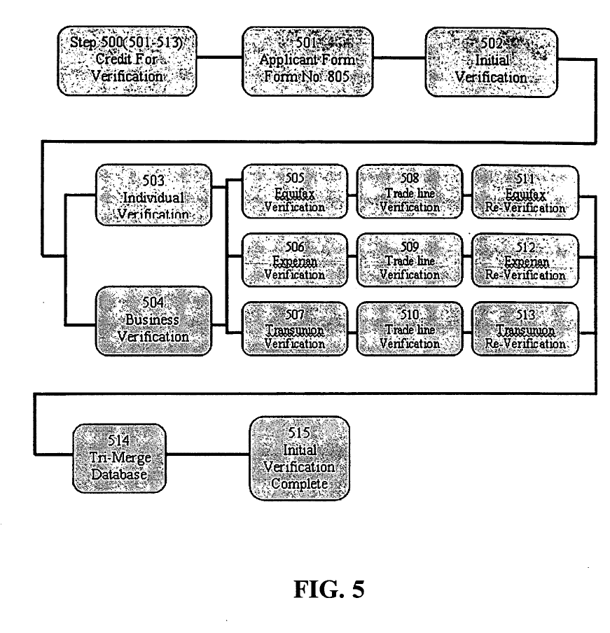

FIG. 5 is a functional flow diagram showing the credit and tradeline collection module 500. The TICCI central processing unit uses the consumer's credit report information and creates a credit report form 501. The credit report information is analyzed using a software program for the accuracy of the credit information 502. The tradelines are reviewed for duplication and sent to the consumer for verification of accuracy 503. The tradelines are analyzed by the software program for incorrect information, questionable information, or aged information 504. Requests for immediately correctable information are created and sent to the specific tradelines 505 and the repositories are contacted to reverify whether the information has been corrected 506. The tradelines must verify the data, and if the data is not confirmed within 30 days, the repositories must remove the incorrect data from the credit history and report. Page A12 of the Appendix provides detailed text for the steps shown in FIG. 5.

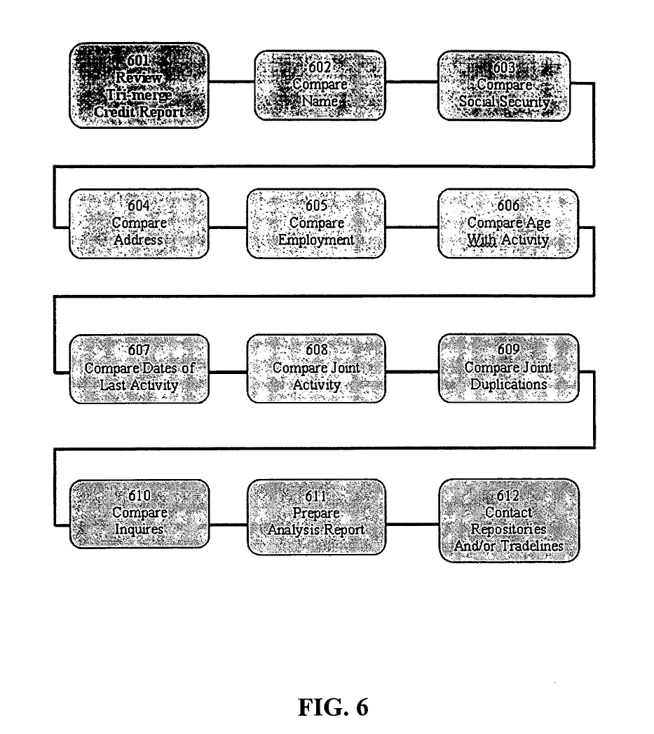

FIG. 6 is a functional flow diagram showing the credit and tradeline analysis module 600. The consumer is sent a credit report and tradeline information for review 601. The consumer and the software program compare all of the consumer's information including, but not limited to their full name, social security number, address, prior addresses, employment, age and dates of credit activity and any other credit information placed on the report to determine incorrect and inaccurate information 602. The consumer and the software program indicate the incorrect information 603. An analysis report 604 is created showing deductions on the credit report and credit scoring 605 and provides suggestions to the consumer for correcting the information 606 and shows the number of inquiries of the consumer's credit history 607. The consumer determines the tradelines to be corrected by answering inquiries prompted by the software program 608 and the consumer provides specific reasons for the incorrect data to be corrected or changed 609, which reasons are provided to the consumer in a drop down menu prepared by the software program 610. Pages A13-A14 of the Appendix provide detailed text of the steps shown in FIG. 6.

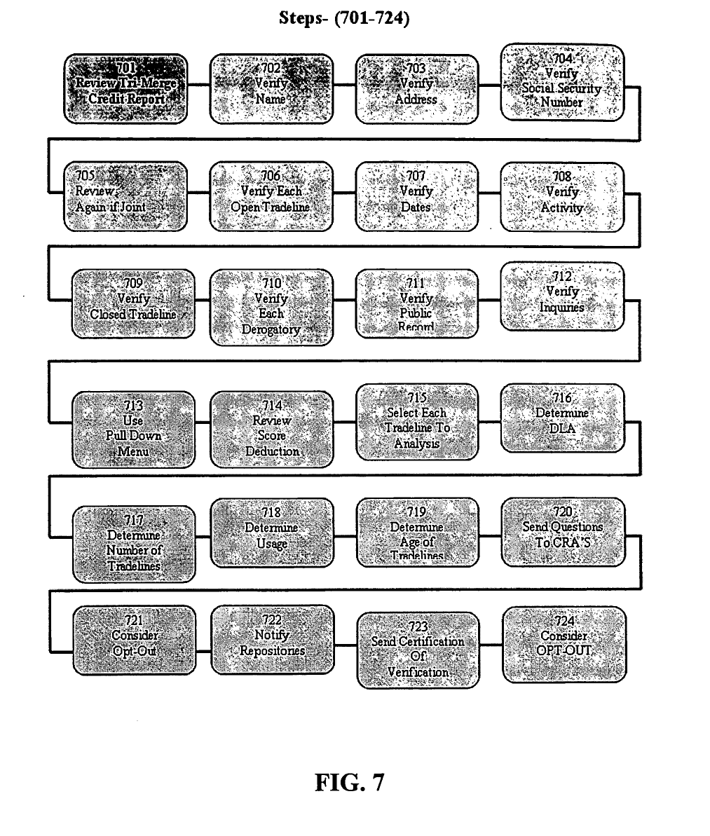

FIG. 7 is a functional flow diagram showing the credit and tradeline correction module 700. The consumer authorizes the tradelines to be contacted 701, and the TICCI central processing unit sends via online or other communication system requests generated by the software program 702 that requests the tradelines to verify or correct incorrect credit information 703. The TICCI central processing unit also sends via online or other communication system requests to the repositories to correct any immediately correctable information 704 such as removing old or aged information and any other immediately correctable information. The TICCI central processing unit also sends via online or other communication system requests to tradelines that have questionable information or to reduce excessive number of tradelines or negotiate with tradelines 705. The software program determines the usage rate 706, which is a ratio that analyzes the possibility of reducing the consumer's credit score and provides the consumer with an analysis of actions to be taken to improve the consumer's credit score 707. The TICCI central processing unit contacts the repositories to re-verify the consumer's information at set intervals, and will contact the consumer to re-verify the credit information until corrected 708. Pages A15-A17 of the Appendix provide detailed text for the steps shown in FIG. 7.

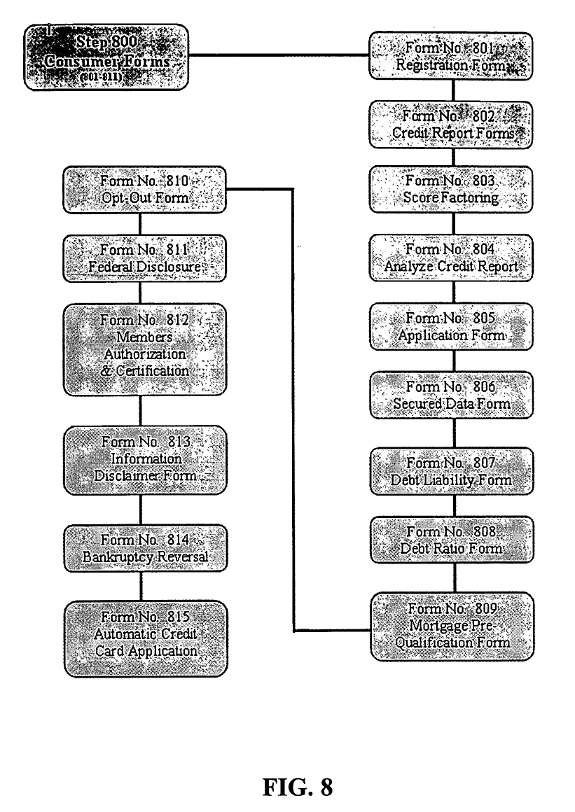

FIG. 8 is a functional flow diagram showing the consumer form creation module 800. The Appendix contains the forms created by the FIG. 8 program. The software program uses the database and creates forms using the consumer credit information. The registration form 801 is created to permit the consumer to view their registration information and to correct any incorrect information. The credit report forms 802 are created to report to the consumer the credit information provided by the Tri Merge agencies or the repositories. The score factoring form 803 is created to provide the consumer with a credit score to review. The analysis report 804 is created to provide the consumer with the software programs analysis of the consumer's credit information. The application form 805 is created to provide specific information regarding the consumer for registration to the software program. The secured data form 806 is created to obtain and permit the consumer to change personal information that is used to determine certain credit ratio's and to obtain credit information of the consumer. The debt liability form 807 is created to provide the consumer with a list of credit information obtained from the credit reports. The debt ratio form 808 is created to show the consumer the calculation of the consumer's debt to income ratio and provide information relating to the risk of high and low debt ratios. The federal disclosure form 809 is created for the consumer's review, which provides the consumer with information regarding the consumer's credit information and the consumer's rights. The Members authorization and certification form 810 is created, and provides the consumer's authorization for obtaining credit information. The information disclaimer form 811 is created, providing the consumer with any appropriate disclaimers regarding the analysis of the consumer's credit information. Page A18 of the Appendix provides detailed text for the steps shown in FIG. 8. Pages A19-A33 show the forms created by/associated with the FIG. 8 flow diagram. Pages A43-A52 of the Appendix show the data base fields and program formulas employed to obtain and insert the information requested in the above mentioned forms.

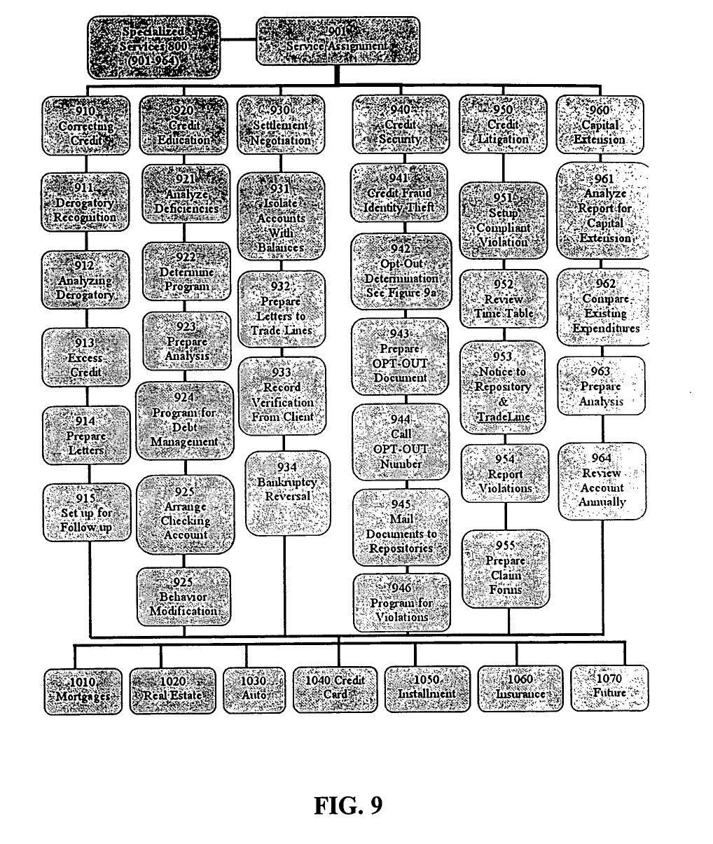

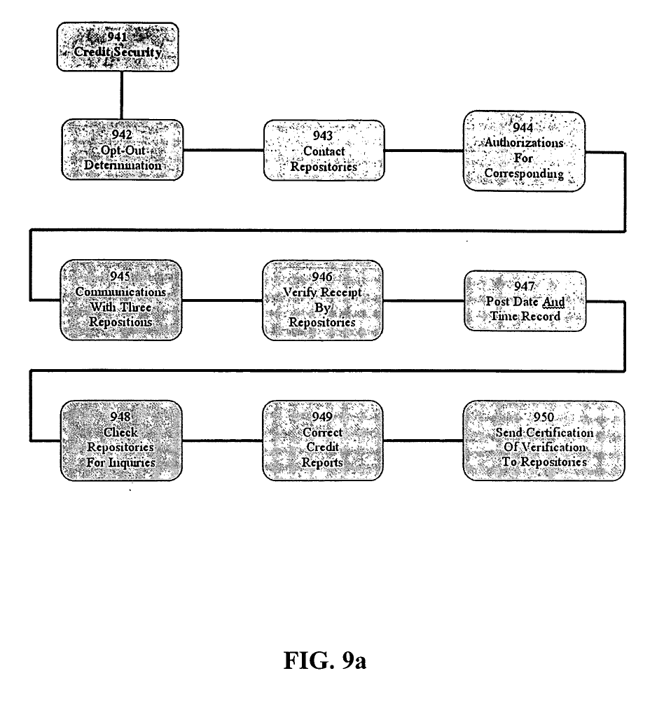

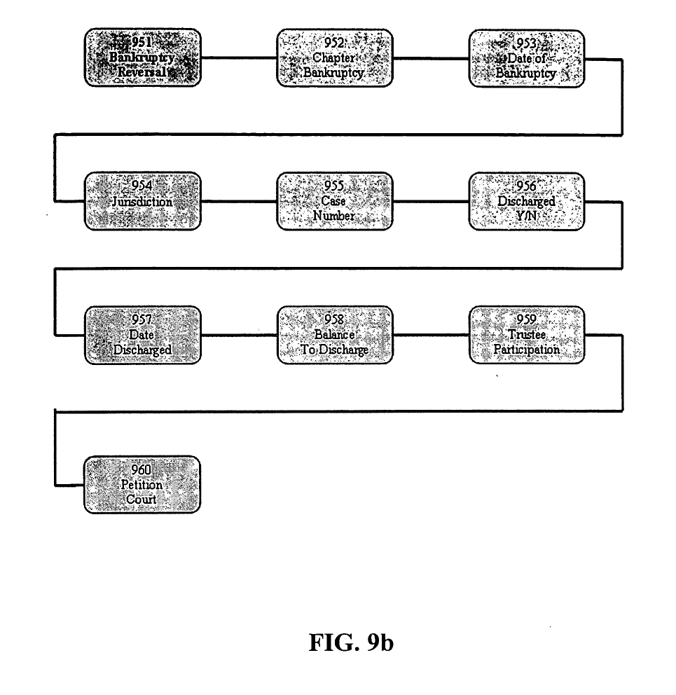

FIG. 9 is a functional flow diagram showing the specialty services module 900. The consumer is prompted to choose services relating to the consumer's credit. The services include the credit correction service 910, the credit education 920, settlement negotiation service 930, credit security service 940, credit litigation service 950, capital extension service 960, and the bankruptcy reversal service 970.

The credit correction service provides the consumer with the ability to correct incorrect credit information that is on file with the repositories. The consumer follows the steps in modules 400 to 800. The credit education service analyzes deficiencies 921 in the consumer's credit history as reflected on the consumer's credit report. The software program determines the credit programs that may benefit the consumer 922. The software program creates an analysis of the programs for the consumer 923. The software program creates for the consumer a debt management program 924. The software program creates for the consumer a checking account 925 that will pay bills for the consumer. The software program creates a behavior modification analysis 926 that provides the consumer with alternatives and instructions as to how the consumer may change their credit practices and aid the consumer in controlling their credit. The settlement negotiation service provides the consumer with services for negotiating settlements and reducing balances on credit accounts. The software program will identify accounts maintaining balances that may be negotiated 931. The consumer will select the accounts to be negotiated 932, and requests will be sent to the tradelines beginning the settlement process 933. Upon negotiating a settlement, an authorization and verification will obtained from the consumer 934 that approves the settlement.

The credit security service is provided to the consumer in order to protect the consumer from abuse of the consumer's credit history. The credit security service provides the consumer with opting out from having the consumer's credit history and information sold or transferred by the repositories without specific authorization from the consumer. The credit security service also provides the consumer with protection from credit identity fraud. The consumer reviews the credit information provided from the repositories for unknown accounts 941. The TICCI central processing unit contacts the unknown account tradelines 942 to discuss closing the account and verifying the account holder. The consumer is notified by the TICCI central processing unit via online or other communication system of new accounts or activities on unknown accounts 943. The consumer can use the opt-out sequence 944 in order to stop the sale or transfer of the consumer's credit information without specific authorization by the consumer.

The credit litigation service permits the consumer to obtain judgments and settlements against tradelines that do not comply with the Fair Credit and Reporting Act (FCRA). The consumer is provided with an analysis of the tradelines and repositories in the consumer's credit information that have not complied with the FCRA 951. The software program creates a complaint form 952 and obtains authorization from the consumer to file the complaint form 953. The complaint form is sent to the tradeline or repository via online or other communication system 954. The software program tracks the time, as the FCRA requires that the repository or tradeline verify the disputed information within thirty (30) days 955. If the information is verified or corrected, no further action is taken 956. If the information is not corrected or verified, then a second notice stating the violation is sent to the tradeline and repository via online or other communication system 957. The software creates a complaint or incident report that is sent to the Federal Trade Commission and State Protection Agency 958. If the complaint is not resolved, the consumer is provided with the option to pursue litigation 959.

The capital extension service provides savings programs for the consumer. The software program analyzes the debt ratio form and consumer profile in the database 961. The consumer is provided with an analysis of their spending, income and expenses 962. The software program provides the consumer with suggestions and alternatives to help the consumer save on expenses 963. At specified intervals, the consumer's credit information will be re-analyzed, and the consumer is provided with updated analyses 964. Pages A34-A36 of the Appendix provide detailed text for the steps shown in FIG. 9.

FIG. 9a is a functional flow diagram of the opt-out sequence. Consumer's information is sold and transferred by the repositories. The consumer can choose to stop the repositories from selling or transferring the consumer's information. The software program provides the consumer with an opt-out analysis 945 of the incorrect information in the consumer's credit history on file at the repositories. If the consumer chooses the opt-out service, the software program creates an opt-out authorization form 946 requesting the repositories to stop selling and transferring the consumer's information and directing the repositories regarding contact information. The TICCI central processing unit sends the opt-out authorization form to the repositories via online or other communication system 947. The TICCI central processing unit verifies the receipt of the opt-out authorization form, and the consumer's credit history is reviewed at intervals to determine whether the repositories are complying with the opt-out authorization 948. The repositories are sent an authorization to renew selling and transferring of the consumer's information once authorized by the consumer 949. Page A37 of the Appendix provides detailed text for the steps shown in FIG. 9a.

FIG. 9b is a functional flow diagram of the bankruptcy reversal sequence. The consumer provides information relating to the bankruptcy proceedings that involved the consumer 971. The software program analyzes the bankruptcy information contained in the credit history to that provided by the consumer 972. The software program provides an analysis of the potential to reverse the consumer's bankruptcy 973 and the effect on the consumer's credit score 974. If the consumer wants to proceed with bankruptcy reversal, the TICCI central processing unit contacts an attorney in the appropriate jurisdiction and provides the attorney with the required information for obtaining a bankruptcy reversal 975. Page A38 of the Appendix provides detailed text for the steps shown in FIG. 9b.

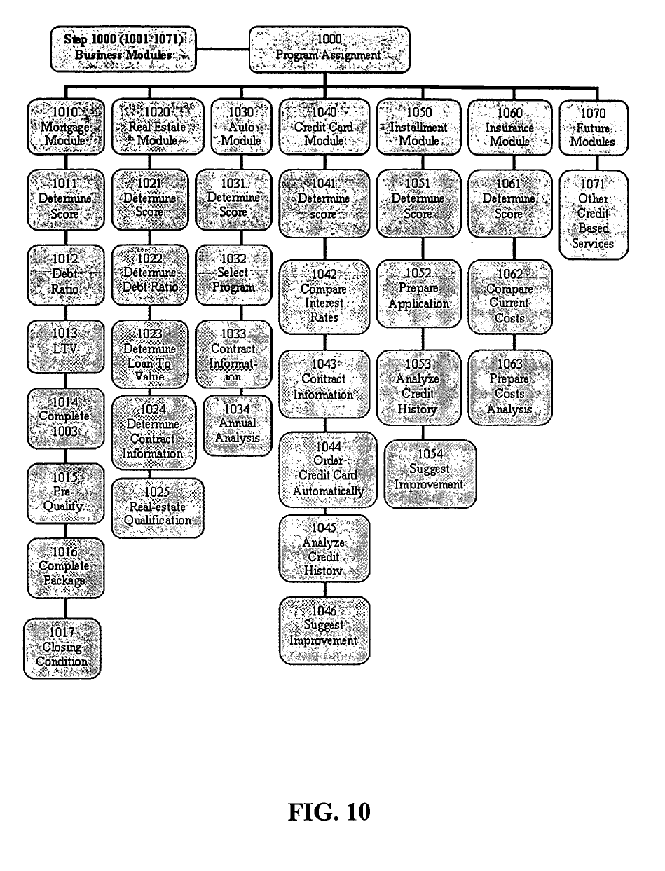

Referring to FIG. 10 is a functional flow diagram of the business modules available to the consumer. The business modules are the mortgage module 1010, the real estate module 1020, the auto loan module 1030, the credit card module 1040, the merchant installment module 1050, the insurance module 1060, and other credit services modules 1070. The benefit of correcting credit in order to obtain a lower credit score is evident in the business modules, and provides the consumer with the ability to save money and be awarded better credit facilities.

The mortgage module helps the consumer find competitive loans. The software program determines the consumer's credit score 1011 and debt ratio 1012. The software program creates a loan to value illustration for the consumer 1013 illustrating such information as the difference in interest rates of certain loans and the monthly payments and other loan information. The software program uses the information contained in the database relating to the consumer and creates a mortgage form 1014, and prompts the consumer for any required additional information 1015. The TICCI central processing unit contact via online or other communication system lending institutions for loan pre-qualification 1016, and reports the loan information and results to the consumer 1017. The software program creates a mortgage correction analysis 1018 as to whether the consumer's credit score could be lowered and thus obtain a better loan by using the credit correction module 200. The consumer may choose to elect any of the current loans, or proceed to correct the consumer's credit and begin the mortgage process again with a corrected credit history 1019.

The real estate module provides the consumer with the necessary steps to purchase real estate. The consumer chooses the real estate module 1021. The software program determines a credit score 1022 for the consumer after obtaining the consumer's credit history from the repositories. The software program determines the debt ratio and provides a credit analysis to the consumer on alternatives and ways to improve the debt ratio and credit score 1023. The software program determines the loan to value percentage of the consumer 1024 and creates a real estate information form 1025 using the credit information and consumer information in the database. The consumer is required to correct and provide any additional information required 1026. The software program analyzes the information and provides the consumer with a real estate report 1027 illustrating the potential qualification for the consumer and the benefit of correcting the consumer's credit 1028. The consumer may elect to proceed or to have the consumer's credit corrected by using the credit correction module 200. If the consumer elects to proceed, the TICCI central processing unit sends the completed real estate information form via online or other communication system to start the real estate purchase process 1029.

The auto loan module provides the consumer with an analysis to determine the consumer's eligibility to purchase or lease an automobile and qualify for a loan. The consumer chooses the auto loan module 1031. The software program after obtaining the consumer's credit information from the repositories, determines the consumer's credit score 1032. The software program identifies the auto programs available to the consumer based on the consumer's credit score 1033. The software program provides an analysis to the consumer on the auto programs and the consumer's eligibility and illustrates the particulars of each auto program 1034. The software program analyzes the consumer's credit information and provides the consumer with an analysis as to the auto programs that would be available to the consumer if the consumer corrects the consumer's credit information 1035. The consumer may elect to proceed or to have the consumer's credit corrected by using the credit correction module 200. If the consumer elects to proceed, the software program will create a loan and sales application form 1036 using the consumer's credit information and the consumer information contained in the database 1037. The consumer will provide any other required information to complete the form 1038, and the TICCI central processing unit will send the form via online or other communication system to the potential lenders and continue the contact between the consumer and the lenders until the loan transaction is finalized or abandoned 1039.

The credit card module provides the consumer with credit card information relating to the consumer's eligibility for different credit benefits. The consumer chooses the credit card service 1040. The software program after obtaining the consumer's credit information from the repositories determines the consumer's credit score 1041. The software program compares credit card interest rates contained in the database provided by credit card companies and provides the consumer with a credit card report 1042 listing the lowest rates and benefits. The software program provides the consumer with a credit correction analysis 1043 illustrating the change in the credit card interest rates by correcting the consumer's credit information and suggesting alternatives to improve the consumer's credit score. The consumer may elect to proceed or to have the consumer's credit corrected by using the credit correction module 200 to correct the consumer's credit information and receive a better interest rate. If the consumer elects to proceed, the software program will create a credit card application form using the consumer information, database information and prompting the consumer to provide any additional required information 1044. The consumer elects to apply for credit cards listed in the credit card report 1045 and the TICCI central processing unit contacts and sends the credit card application via online or other communication system to the credit card providers elected by the consumer 1046.

The merchant installment module provides the consumer with information relating to other credit facility businesses such as department stores and businesses offering installment credit options. The consumer chooses the merchant installment service 1050. The software program after obtaining the consumer's credit information from the repositories determines the consumer's installment credit score 1051. The software provides the consumer with the rate and credit information relating to the merchant's installment program 1052. The software program provides the consumer with a credit correction analysis 1053 illustrating the change in the installment program interest rate and installment program by correcting the consumer's credit information and suggesting alternatives to improve the consumer's installment credit score. The consumer may elect to proceed or to have the consumer's credit corrected by using the credit correction module 200 to correct the consumer's credit information and receive a better interest rate. If the consumer elects to proceed, the software program will create an installment application form using the consumer information, database information and prompting the consumer to provide any additional required information 1054. The consumer elects to apply for the installment program listed for the merchant 1055 and the TICCI central processing unit contacts and sends the installment application via online or other communication system to the merchant 1056.

The insurance service module provides the consumer with information relating to insurance rates for consumer products such as auto, home and life insurance. The consumer chooses the insurance service 1060. The software program after obtaining the consumer's credit information from the repositories determines the consumer's insurance credit score 1061. The software provides the consumer with the rate and credit information relating to different insurance programs 1062. The software program provides the consumer with a credit correction analysis 1063 illustrating the change in the insurance premiums by correcting the consumer's credit information and suggesting alternatives to improve the consumer's installment credit score. The consumer may elect to proceed or to have the consumer's credit corrected by using the credit correction module 200 to correct the consumer's credit information and receive a better premium. If the consumer elects to proceed, the software program will create an insurance application form using the consumer information, database information and prompting the consumer to provide any additional required information 1064. The consumer elects to apply for the insurance 1065 and the TICCI central processing unit contacts and sends the insurance application via online or other communication system to the merchant 1066. Pages A39-A42 provide detailed text for the steps shown in FIG. 10.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method for performing an automatic on-line review and correction of a consumer's credit information by a central processor having and executing a software program, comprising the steps of:
receiving a set of personal data into a database and communication system, said personal data relating to information provided by said consumer from a workstation;
requesting a credit report of the consumer's credit information from a credit repository using said personal data;
receiving a credit report of said consumer into said database and communication system, relating to a consumer's credit information;
verifying the consumer's credit information by the consumer;
verifying the consumer's credit information by the software program;
identifying incorrect consumer information relating to a tradeline;
creating a correction request to correct the incorrect consumer information;
sending the correction request to the credit repository; and
re-verifying the incorrect information has been corrected by the repository.

2. The method of claim 1, further comprising:
interacting online with the consumer at the workstation.

3. The method of claim 1, further comprising:
receiving the credit information from a tri merge agency.

4. The method of claim 1, further comprising:
removing from the credit information verified by the consumer any multiple tradeline entries.

5. The method of claim 1, further comprising:
creating a security profile for the consumer.

6. The method of claim 5, further comprising:
looping the consumer's workstation with the central processing unit;
using a storage media by the consumer to hold the consumer's personal information;
creating a security code for the storage media; and
granting access to the central processing unit when the storage media is looped with the central processing unit with the proper security code.

7. The method of claim 1, further comprising:
granting the consumer access while using a business workstation.

8. The method of claim 7, further comprising:
creating a business security code for the business workstation; and
granting access to the central processing unit when the business security code is validated by the central processing unit.

9. The method of claim 1, further comprising:
interacting online with a repository.

10. The method of claim 1, further comprising:
creating a credit score for the consumer.

11. The method of claim 10, further comprising:
creating a credit correction analysis for the consumer relating an expected increase in the consumer's credit score.

12. The method of claim 1, further comprising:
sending the correction request to the tradeline that is identified as having incorrect credit information.

13. The method of claim 1, further comprising:
sending the correction request to the tradeline that has incorrect credit information in the form of an aged credit information.

14. The method of claim 1, further comprising:
sending the correction request to the repository setting forth the incorrect aged credit information.

15. The method of claim 1, further comprising:
sending the correction request to the repository setting forth the incorrect personal information.

16. The method of claim 1, further comprising:
sending the correction request to the tradeline setting forth the incorrect personal information.

17. The method of claim 1, further comprising:
sending the correction request to the repository requesting that the repository remove at tradeline due to excessive numbers of tradelines.

18. The method of claim 1, further comprising:
analyzing the consumer's credit information;
creating a specialty service analysis;
sending the specialty service analysis to the consumer; and
offering a specialty service module.

19. The method of claim 18, further comprising:
offering to the consumer a credit correction service.

20. The method of claim 18, further comprising:
offering to the consumer a credit education service.

21. The method of claim 18, further comprising:
offering to the consumer a settlement negotiation service.

22. The method of claim 18, further comprising:
offering to the consumer a credit security service.

23. The method of claim 18, further comprising:
offering to the consumer a credit litigation service.

24. The method of claim 18, further comprising:
offering to the consumer a capital extension service.

25. The method of claim 18, further comprising:
offering a bankruptcy reversal service.

26. The method of claim 1, further comprising:
analyzing the consumer's credit information;
producing an explanation of potential business services available to the consumer; and
offering the consumer a business module containing business services.

27. The method of claim 26, further comprising:
offering to the consumer a mortgage loan service.

28. The method of claim 26, further comprising:
offering to the consumer a real estate service.

29. The method of claim 26, further comprising:
offering to the consumer an auto loan service.

30. The method of claim 26, further comprising:
offering to the consumer a credit card service.

31. The method of claim 26, further comprising:
offering to the consumer a merchant installment service.

32. The method of claim 1, further comprising:
offering to the consumer an insurance service.

33. The method of claim 1, further comprising:
creating an opt-out analysis;
sending to the consumer the opt-out analysis; and
offering the consumer an opt-out service.

34. The method of claim 33, further comprising:
creating an opt-out authorization for the consumer asking the repository to stop selling or transferring the consumer's credit information without first obtaining authorization form the consumer;
receiving the opt-out authorization from the consumer;
sending the opt-out authorization to the repository;
verifying that the opt-out authorization is received by the repository; and
verifying that the repositories abide by the requests set forth in the opt-out authorization.

35. The method of claim 34, further comprising:
verifying that the consumer's credit information has been corrected;
receive authorization from the consumer to terminate the opt-out authorization; and
sending an opt-out termination to the repositories, which permits the repositories to sell or transfer the consumer's credit information.

36. The method of claim 20, further comprising:
creating a credit education analysis;
sending to the consumer the credit education analysis;
recommending to the consumer a credit education program for debt management; and
arranging a checking account for the consumer further comprising expenses of the consumer will be paid from the checking account.

37. The method of claim 21, further comprising:
reviewing the credit information;
identifying credit information that may be negotiated;
producing a settlement report to the consumer identifying a set of tradeline accounts that may be negotiated;
receiving a negotiation authorization from the consumer to negotiate settlements for the consumer;
preparing a set of negotiation letters to the tradeline accounts setting forth the consumer's negotiation authorization;
negotiating with the account tradelines;
verifying a set of settlements with the consumer for settlements negotiated with the account tradelines; and
obtaining executed settlements with the consumer and account tradelines.

38. The method of claim 22, further comprising:
receiving the opt-out authorization;
reviewing the consumer's credit information by the consumer;
reviewing the consumer's credit information by the software program;
identifying a set of unknown tradeline accounts;
contacting the unknown tradeline accounts to determine the accuracy of the consumer's credit information set forth on the unknown tradeline account;
correcting the consumer's credit information at the unknown tradeline account;
closing the unknown tradeline account if the consumer credit information is not corrected;
closing the unknown tradeline account if the consumer credit information is not verified; and
contacting the repositories to correct the consumer's credit information.

39. The method of claim 23, further comprising:
reviewing the consumer's credit information;
identifying a set of litigation accounts further comprising the litigation accounts consists of a set of tradeline litigation accounts and a set of repository litigation accounts that have not complied with the provisions of the Fair Credit and Reporting Act;
creating a credit litigation analysis for the consumer, that sets forth the set of litigation accounts;
sending the credit litigation analysis to the consumer;
receiving authorization from the consumer to create a litigation complaint form for the litigation accounts specified by the consumer;
sending the litigation complaint form to the repositories and tradelines specified by the consumer;
reviewing the consumer's credit information periodically to determine whether the repositories and tradelines have corrected the consumer's credit information;
sending a second litigation complaint form if the consumer's credit information has not been corrected;
creating an incident report;
sending the incident report to the Federal Trade Commission and State Protection Agency; and
providing the consumer with an option proceed with litigation in the event that the consumer credit information has not been corrected.

40. The method of claim 24, further comprising:
reviewing the consumer's credit information;
creating a capital extension analysis using a debt ratio calculation and a consumer profile;
providing the consumer with a capital extension recommendation derived from the capital extension analysis;
updating periodically the consumer's credit information;
reviewing the consumer's credit information; and
providing an updated capital extension recommendation to the consumer.

41. The method of claim 25, further comprising:
receiving from the consumer a set of bankruptcy information;
creating a bankruptcy reversal analysis derived from the set of bankruptcy information;
providing the consumer with the bankruptcy reversal analysis;
receiving from the consumer a bankruptcy reversal authorization;
contacting a bankruptcy reversal attorney in the consumer's jurisdiction;
sending the authorization to the bankruptcy reversal attorney, which includes the personal information of the consumer; and
sending the bankruptcy reversal analysis to the bankruptcy reversal attorney.

42. The method of claim 27, further comprising:
creating a mortgage credit score from the consumer's credit information;
receiving from the consumer a set of mortgage information;
creating a mortgage debt ratio from the consumer's credit information and set of mortgage information;
creating a loan to value illustration showing a plurality of mortgage lending institution information;
sending the loan to value illustration to the consumer;
receiving authorization to contact a plurality of mortgage lending institutions;
receiving a plurality of pre-qualification loans from the mortgage lending institutions;
sending the plurality of pre-qualification loans to the consumer;
receiving authorization from the consumer to obtain a mortgage from an identified mortgage lending institution; and
obtaining a mortgage lending commitment from the identified mortgage lending institution.

43. The method of claim 42, further comprising:
creating a loan to value illustration further comprising a mortgage correction analysis that shows the consumer any potential changes in the mortgage lending institution information if the consumer elects to correct the consumer's credit information.

44. The method of claim 43, further comprising:
electing to correct the consumer's credit information.

45. The method of claim 28, further comprising:
creating a real estate credit score from the consumer's credit information;
receiving from the consumer a set of real estate information;
creating a real estate debt ratio from the consumer's credit information and set of real estate information;
creating a loan to value illustration showing a plurality of real estate institution information;
sending the loan to value illustration to the consumer; and
receiving authorization to proceed with a real estate purchase process.

46. The method of claim 45, further comprising:
creating a loan to value illustration further comprising a real estate correction analysis that shows the consumer any potential changes in the real estate institution information if the consumer elects to correct the consumer's credit information.

47. The method of claim 46, further comprising:
electing to correct the consumer's credit information.

48. The method of claim 29, further comprising:
creating an auto credit score from the consumer's credit information;
receiving from the consumer a set of auto information;
identifying a plurality of auto loan programs available to the consumer based on the consumer's credit information and the auto information;
receiving from the consumer a list of auto loan programs identified by the consumer for obtaining an auto loan;
creating an auto loan application for the auto loan programs identified by the consumer from the consumer's credit information and auto information;
sending the auto loan application to the auto loan programs identified by the consumer;
receiving an auto loan qualification from the auto loan programs; and
receiving an auto loan authorization from the consumer to obtain an identified auto loan.

49. The method of claim 48, further comprising:
creating an auto loan correction analysis that shows the consumer any potential changes in the auto loan programs if the consumer elects to correct the consumer's credit information.

50. The method of claim 49, further comprising:
electing to correct the consumer's credit information.

51. The method of claim 30, further comprising:
creating a credit card credit score from the consumer's credit information;
identifying a plurality of credit card programs available to the consumer based on the consumer's credit information;
receiving from the consumer a list of credit card programs identified by the consumer for obtaining a credit card;
creating a credit card application for the credit card programs identified by the consumer from the consumer's credit information and personal information;
sending the credit card application to the credit card programs identified by the consumer; and
receiving a credit card acceptance from the credit card programs.

52. The method of claim 51, further comprising:
creating a credit card correction analysis that shows the consumer any potential changes in the credit card programs if the consumer elects to correct the consumer's credit information.

53. The method of claim 52, further comprising:
electing to correct the consumer's credit information.

54. The method of claim 31, further comprising:
creating an installment credit score from the consumer's credit information;
identifying a plurality of merchant installment programs available to the consumer based on the consumer's credit information;
receiving from the consumer a list of merchant installment programs identified by the consumer for obtaining an installment program;
creating an installment application for the installment programs identified by the consumer from the consumer's credit information and personal information; and
sending the installment application to the installment programs identified by the consumer.

55. The method of claim 54, further comprising:
creating a merchant installment correction analysis that shows the consumer any potential changes in the merchant installment programs if the consumer elects to correct the consumer's credit information.

56. The method of claim 55, further comprising:
electing to correct the consumer's credit information.

57. The method of claim 32, further comprising:
creating an insurance credit score from the consumer's credit information;
identifying a plurality of insurance programs available to the consumer based on the consumer's credit information;
receiving from the consumer a list of insurance programs identified by the consumer for obtaining an insurance premium;
creating an insurance application for the insurance programs identified by the consumer from the consumer's credit information and personal information; and
sending the insurance application to the insurance programs identified by the consumer.

58. The method of claim 57, further comprising:
creating an insurance correction analysis that shows the consumer any potential changes in the insurance programs if the consumer elects to correct the consumer's credit information.

59. The method of claim 58, further comprising:
electing to correct the consumer's credit information.
